(19) United States
(12) Patent Application Publication
(10) Pub. No.: US 2008/0133234 A1
(43) Pub. Date: Jun. 5, 2008

(54) VOICE DETECTION APPARATUS, METHOD, AND COMPUTER READABLE MEDIUM FOR ADJUSTING A WINDOW SIZE DYNAMICALLY

(75) Inventor: Ing-Jr Ding, Taipei (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: INSTITUTE FOR INFORMATION INDUSTRY, Taipei (TW)

(21) Appl. No.: 11/679,781

(22) Filed: Feb. 27, 2007

(30) Foreign Application Priority Data
Nov. 30, 2006 (TW) 095144391

(51) Int. Cl. G10L 15/00

(52) U.S. Cl. 704/239

(57) ABSTRACT

A dividing module divides a voice signal into voice frames. A likelihood value generation module compares each of the voice frames with a first voice model and a second voice model to generate first likelihood values and second likelihood values. A decision module decides a windows size according to the first likelihood values and the second likelihood values. An accumulation module accumulates the first likelihood values and the second likelihood values inside the window size to generate a first sum and a second sum. A determination module determines whether the voice signal is abnormal according to the first sum and the second sum. While the voice has a big change in the environment, the decision module can dynamically adapt the windows size for decreasing the false rate of the detection and speeding up the determining of the abnormal voice.

This application claims priority to Taiwan Patent Application No. 095144391 filed on Nov. 30, 2006.

### CROSS-REFERENCES TO RELATED APPLICATIONS

Not applicable.

### BACKGROUND OF THE INVENTION

1. Field of the Invention

The present invention relates to a voice detection apparatus, a method, and a computer readable medium thereof. More specifically, it relates to a voice detection apparatus, a method, and a computer readable medium capable of deciding a window size dynamically

2. Descriptions of the Related Art

With the development of voice detection techniques in recent years, various voice detection applications are produced. In general voice detection, detected voices can be classified into two major types: a normal voice and an abnormal voice. The normal voice is the voice that is relatively not noticed in an environment, such as voices of a vehicle on a street, voices of people talking, and voices of broadcasting music, etc. The abnormal voice is the voice that is noticed, such as voices of screaming, voices of crying and voices of calling for help, etc. Especially for the aspects of security assurance and surveillance, the voice detection can help security service personnel to handle emergency.

A Gaussion Mixture Model (GMM) is frequently used for voice recognition or speaker recognition in recent years. The GMM is an extension of a MonoGaussian Model (MGM) which uses a mean vector to record the center positions of a number of samples in a vector space and performs an approximate calculation on the shapes of these samples distributed in the vector space with a covariance matrix. Except that the GMM has a characteristic of the MGM, the model also combines a characteristic of a Vector Quantization (VQ) which is capable of recording some material positions of various types of the samples in the vector space.

FIG. 1 shows a conventional voice detection apparatus 1 which comprises a receiving module 100, a division module 101, a characteristic retrieval module 102, a comparison module 103, an accumulation module 104 and a determination module 105. The voice detection apparatus 1 is connected to a database 106, wherein the database 106 stores a plurality of voice models that are all the GMM and can be classified into two types: a normal voice model and an abnormal voice model. The receiving module 100 is used to receive a voice signal 107 and the division module 101 divides the voice signal 107 into a plurality of voice frames, wherein two adjacent voice frames might overlap. Then, the characteristic retrieval module 102 retrieves characteristic parameters of each voice frame. The comparison module 103 performs a likelihood comparison on the characteristic parameters of each voice frames based on the normal and abnormal voice models pre-stored in the database 106 to generate a plurality of first likelihood values and a plurality of second likelihood values respectively. The accumulation module 104 accumulates the first likelihood values and the second likelihood values respectively according to a window size, wherein the window size corresponds to a fixed period of time. As shown in FIG. 2, the voice signal 107 can be divided into a plurality of areas such as areas 21, 22, 23, 24 and 25. The size of each area is the window size. Each area comprises many voice frames. Assuming that the window size is 400 ms, the size of the voice frame is 10 ms, and an overlapped portion between two voice frames is 0 ms, then each area comprises 40 voice frames. The accumulation module 104 accumulates all the first likelihood values and the second likelihood values of the 40 voice frames of each area to generate a first sum and a second sum, respectively. The determination module 105 determines whether the voice signal 107 is normal or abnormal according to the first sum and the second sum.

However, since the window size of the conventional voice detection apparatus 1 is fixed, a false possibility of detection will increase substantially while the environment voice or background voice of a voice signal has a significant change. Under such circumstances, the conventional voice detection apparatus 1 fails to respond immediately and correctly because the change of the environment voice would be treated as abnormal voices. Consequently, how to dynamically adjust the window size to enhance the overall performance of the voice detection apparatus is a serious problem in the industry.

### SUMMARY OF THE INVENTION

One objective of this invention is to provide a voice detection apparatus comprising a receiving module, a division module, a likelihood value generation module, a decision module, an accumulation module and a determination module. The receiving module is used to receive a voice signal. The division module is used to divide the voice signal into a plurality of voice frames. The likelihood value generation module is used to compare each of the voice frames with a first voice model and a second voice model to generate a plurality of first likelihood values and second likelihood values. The decision module is used to decide a window size according to the first likelihood values and the second likelihood values. The accumulation module is used to accumulate the first likelihood values and the second likelihood values inside the window size to generate a first sum and a second sum. The determination module is used to determine whether the voice signal is abnormal according to the first sum and the second sum.

Another objective of this invention is to provide a voice detection method comprising the following steps: receiving a voice signal; dividing the voice signal into a plurality of voice frames; comparing each of the voice frames with a first voice model and a second voice model to generate a plurality of first likelihood values and second likelihood values; deciding a window size according to the first likelihood values and the second likelihood values; accumulating the first likelihood values and the second likelihood values inside the window size to generate a first sum and a second sum; and determining whether the voice signal is abnormal according to the first sum and the second sum.

Yet a further objective of the invention is to provide a computer readable medium storing an application program that has code to make a voice detection apparatus execute the above-mentioned voice detection method.

While the environment voice or background voice of a voice signal has a significant change, the invention can dynamically adjust the window size for decreasing the false possibility of the detection so that the response is instant and correct. Especially for the security assurance applications, the invention can detect an abnormal voice more precisely so a real-time response can be transmitted to a security service office in time.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic diagram of a conventional voice detection apparatus;

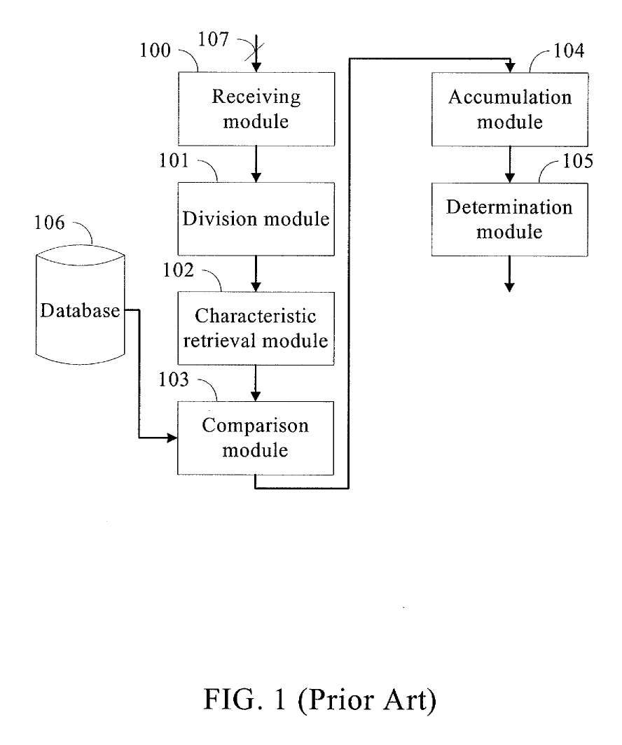

FIG. 2 is a schematic diagram of a conventional decision window;

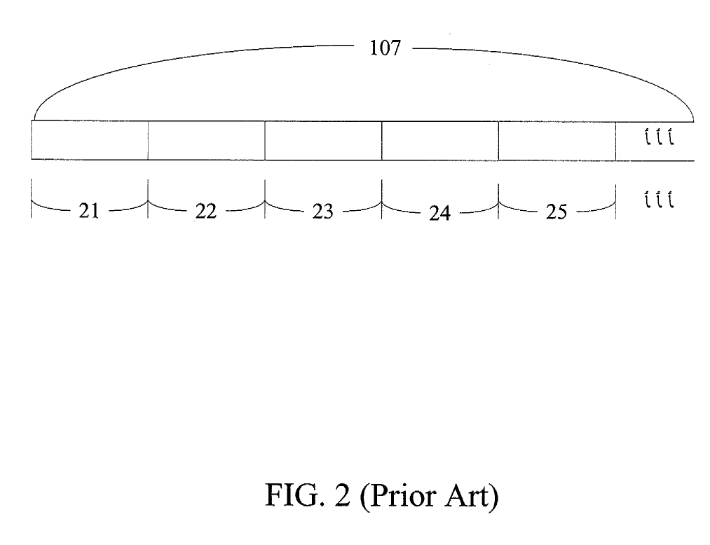

FIG. 3 is a schematic diagram of a first embodiment of the invention;

FIG. 4 is a schematic diagram of a likelihood value generation module of the first embodiment;

FIG. 5 is a schematic diagram of a decision module of the first embodiment;

FIG. 6 is a schematic diagram of a decision window of the invention;

FIG. 7 is a coordinate diagram to show how to calculate a window size of the invention;

FIG. 8 is a flow chart of a second embodiment of the invention;

FIG. 9 is a flow chart of step 802 of the second embodiment;

FIG. 10 is a flow chart of step 803 of the second embodiment;

FIG. 11 is a flow chart of a third embodiment of the invention;

FIG. 12 is a flow chart of step 1102 of the third embodiment; and

FIG. 13 is a flow chart of step 1103 of the third embodiment.

### DESCRIPTION OF THE PREFERRED EMBODIMENT

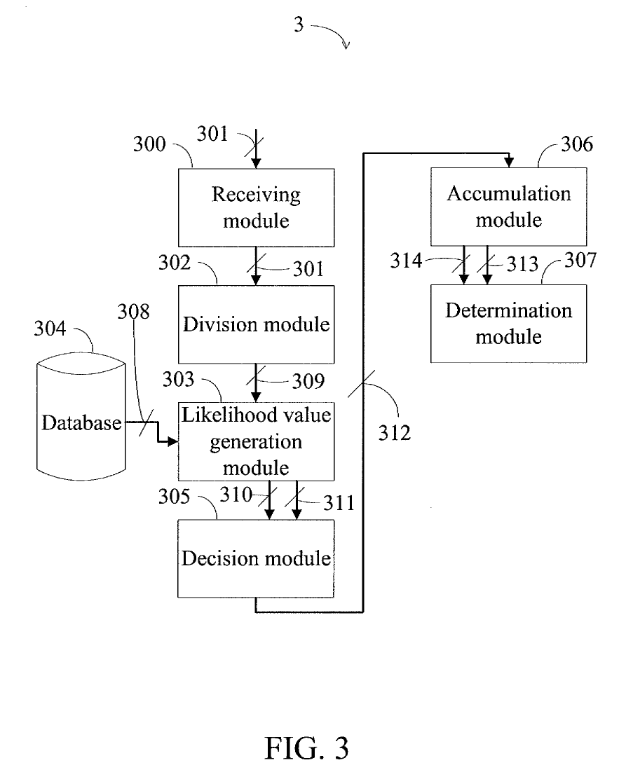

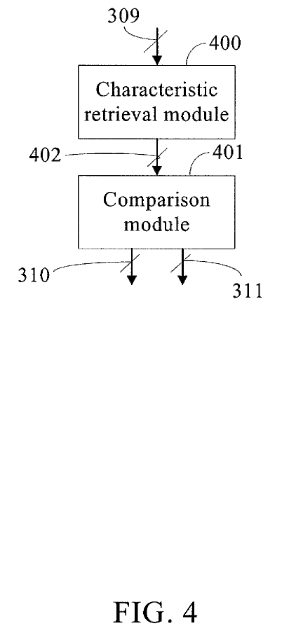

A first embodiment of the invention is shown in FIG. 3 which is a voice detection apparatus 3 that comprises a receiving module 300, a division module 302, a likelihood value generation module 303, a decision module 305, an accumulation module 306 and a determination module 307. The apparatus 3 is connected to a database 304 that stores a plurality of voice models. The voice models are all a Gaussion Mixture Model (GMM) and can be classified into normal voice models and abnormal voice models. The receiving module 300 is used to receive a voice signal 301. The division module 302 is used to divide the voice signal 301 into a plurality of voice frames 309 by utilizing a conventional technique. Two adjacent voice frames of the voice frames 309 might overlap. The voice frames 309 is transmitted to the likelihood value generation module 303 to generate a plurality of first likelihood values 310 and a plurality of second likelihood values 311. FIG. 4 is a schematic diagram of the likelihood value generation module 303. The likelihood value generation module 303 comprises a characteristic retrieval module 400 and a comparison module 401. The characteristic retrieval module 400 retrieves at least one characteristic parameter 402 from each of the voice frames 309. The characteristic parameter 402 can be one of a Mel-scale Frequency Cepstral Coefficient (MFCC), a Linear Predictive Cepstral Coefficient (LPCC), and a cepstral of the voice signal 301, or a combination thereof. The comparison module 401 performs the likelihood comparison on the characteristic parameter 402 with the normal and abnormal voice models 308 pre-stored in the database 304 to generate the first likelihood values 310 and the second likelihood values 311. More particularly, a whole Gaussian mixture density function mainly consists of M component densities, wherein each of the M component densities can be defined by three parameters: a mean vector, a covariance matrix and a mixture weight. In the invention, both a normal voice (the background voice) and an abnormal voice have a corresponding GMM model A which is a set of all the parameters as shown in the following equation:

λ={wᵢ,uᵢ,Σᵢ}, i=1 . . . M

wherein wᵢ represents the mixture weight, μᵢ represents the mean vector, Σᵢ represents the covariance matrix, and M represents the number of a Gaussian distribution. The Gaussian mixture density is a weighted sum of M component densities (i.e., λ) as shown in the following equation:

$$p \text{(} x \vert λ ) = {\sum }_{i = 1}^{M} {w}_{i} {b}_{i} ( x )$$

wherein x is a random vector in D dimensions or a characteristic vector of one voice frame in D dimensions, bᵢ(x), i=1, . . . , M is component densities, wᵢ, i=1, . . . , M is mixture weights satisfying a limitation that a summation of all M mixture weights should be 1, i.e.,

$${\sum }_{i = 1}^{M} {w}_{i} = 1.$$

Each of the component densities bᵢ(x), i=1, . . . , M is the D dimensional Gaussian density function as shown in the following equation:

$${b}_{i} ( x ) = \frac{1}{{( 2 π )}^{D / 2} {\vert {\sum }_{i} \vert}^{1 / 2}} exp \{ - \frac{1}{2} {( x - {μ}_{i} )}^{T} {\sum }_{i}^{- 1} ( x - {μ}_{i} ) \} , \\ i = 1 , … , M$$

wherein μᵢ is the mean vector and Σᵢ is the covariance matrix.

Assuming that λ₁ and λ₂ respectively represent a GMM model for a normal voice and a GMM model for an abnormal voice, and xᵢ represents a sequence of voice frames, a plurality of likelihood values A and a plurality of likelihood values B are generated after performing the likelihood calculation on each of the voice frames based on λ₁ and λ₂, i.e., based on the equation

$$p \text{(} x \vert λ ) = {\sum }_{i = 1}^{M} {w}_{i} {b}_{i} ( x ) .$$

After performing a logarithm operation on the likelihood values A and B, a plurality of likelihood log values C and a plurality of likelihood log values D are obtained. The likelihood log values C and D are the first likelihood values 310 and the second likelihood values 311, wherein the first likelihood values 310 are the results of performing the likelihood comparison on the normal voice model and the characteristic parameter 402, and the second likelihood values 311 are the results of performing the likelihood comparison on the abnormal voice model and the characteristic parameter 402. Both of the results are transmitted to the decision module 305.

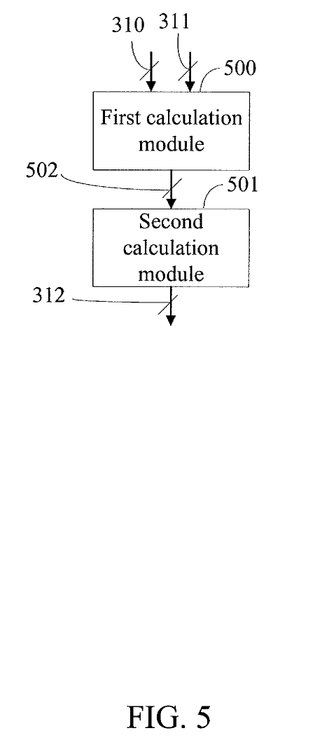

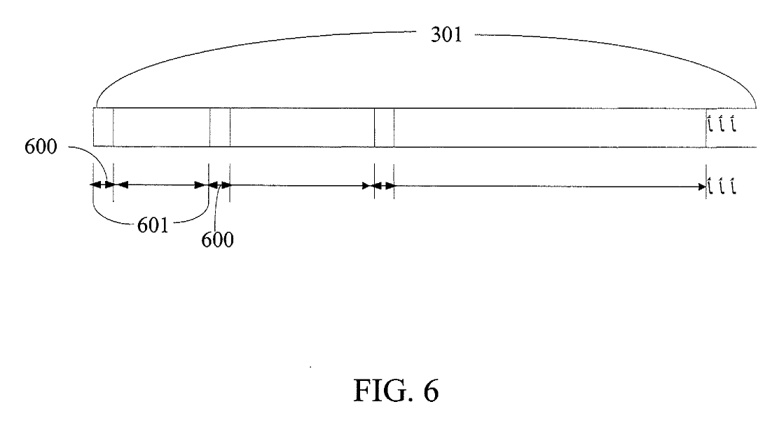

FIG. 5 shows a schematic diagram of the decision module 305. The decision module 305 is used to decide a window size. The decision module 305 comprises a first calculation module 500 and a second calculation module 501. The first calculation module 500 accumulates the first likelihood values 310 and second likelihood values 311 respectively based on a predetermined minimum window in order to generate a minimum window likelihood differential value 502. More particularly, as shown in FIG. 6, assume that the voice signal 301 has a length of 10 seconds, and the size of the voice frame and the size of a minimum window 600 are 5 ms and 100 ms, respectively. The first calculation module 500 accumulates the 20 first likelihood values 310 and the 20 second likelihood values 311 that locate from the beginning to 100 ms. The first calculation module 500 takes the difference of the accumulation results of the first likelihood values 310 and the second likelihood values 311. The minimum window likelihood differential value 502 is the difference.

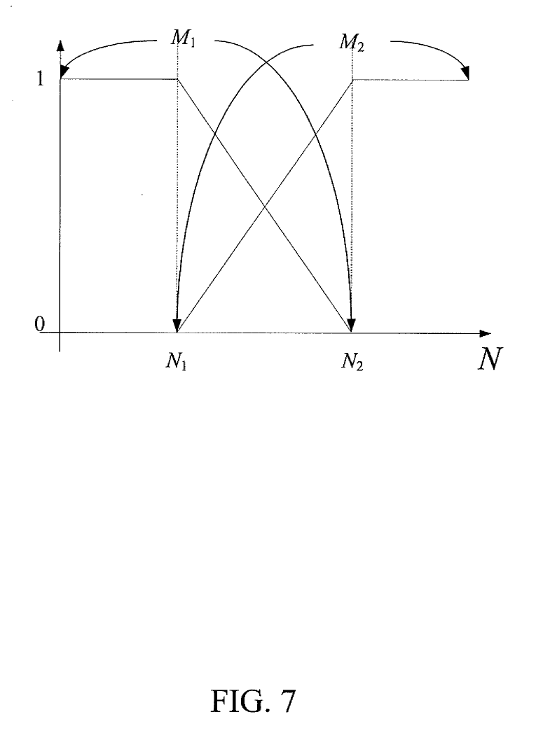

FIG. 7 shows how to derive the window size 312 with the second calculation module 501, wherein the N in the x axis represents minimum window likelihood differential values, and the y axis represents the parameter value. The invention defines a first minimum window likelihood difference constant N₁ and a second minimum window likelihood difference constant N₂. In this embodiment, N₁ and N₂ are 300 and 600, respectively, and stored in the second calculation module 501. Both of N₁ and N₂ can be other constants according to the practical conditions so the values of N₁ and N₂ are not used to limit the scope of this invention. FIG. 7 further shows a first weighting linear equation M₁ and a second weighting linear equation M₂. The weighting linear equations are shown as follows:

$${M}_{1} ( N ) = \{ \begin{matrix} 1 & N \leq {N}_{1} \\ \frac{{N}_{2} - N}{{N}_{2} - {N}_{1}} & {N}_{1} \leq N \leq {N}_{2} \\ 0 & N \geq {N}_{2}\end{matrix} \\ {M}_{2} ( N ) = \{ \begin{matrix} 0 & N \leq {N}_{1} \\ \frac{N - {N}_{1}}{{N}_{2} - {N}_{1}} & {N}_{1} \leq N \leq {N}_{2} \\ 1 & N \geq {N}_{2}\end{matrix}$$

Assuming that the N derived by the first calculation module 500 equals to 480, the second calculation module 401 utilizes the aforementioned first weighting linear equation M₁ and the second weighting linear equation M₂ to derive that M₁(N) is 0.4 and M₂(N) is 0.6.

Furthermore, the number of the voice frames N can be substituted into the following linear equation to derive parameters f₁(N) and f₂(N):

f₁(N)=a₁·N+b₁

f₂(N)=a₂·N+b₂

wherein a₁, a₂, b₁ and b₂ are predetermined constants, and the settings of a₁, a₂, b₁ and b₂ constants should make f₁(N) larger and f₂(N) smaller. In other words, f₁(N) is a larger window value and f₂(N) is a smaller window value. Then, the second calculation module 501 derives the window size 312 according to the following equation:

$$\begin{matrix}window size = \frac{{M}_{1} ( N ) \cdot {f}_{1} ( N ) + {M}_{2} ( N ) \cdot {f}_{2} ( N )}{{M}_{1} ( N ) + {M}_{2} ( N )} \\ = 0.4 {f}_{1} ( N ) + 0.6 {f}_{2} ( N )\end{matrix}$$

By utilizing the equation to derive the window size 312, the window size value is relatively larger while the minimum window likelihood differential value N is a smaller value. On the contrary, the window size value is relatively smaller while the minimum window likelihood differential value N is a larger value. The window size 312 is the size of the decision window 601 in FIG. 6.

Refer back to FIG. 3. After the window size 312 is obtained, the accumulation module 306 accumulates the first likelihood values and the second likelihood values of the voice frames inside the window size 312 to generate a first sum 313 and a second sum 314, respectively. The determination module 307 determines whether the voice signal 301 is abnormal according to the first sum 313 and the second sum 314. If the first sum 313 is greater, the voice signal 301 is determined normal. Otherwise, the voice signal 301 is determined abnormal.

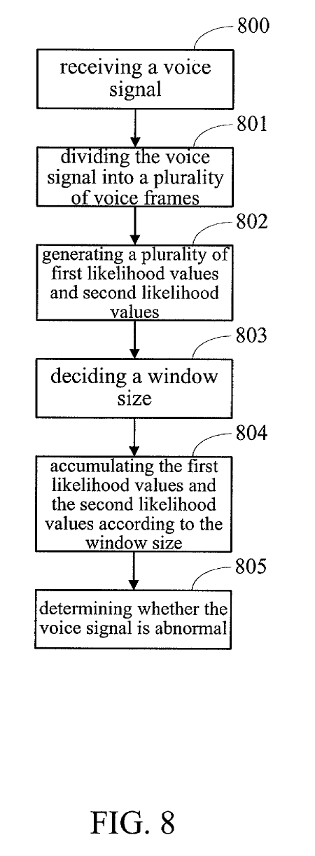

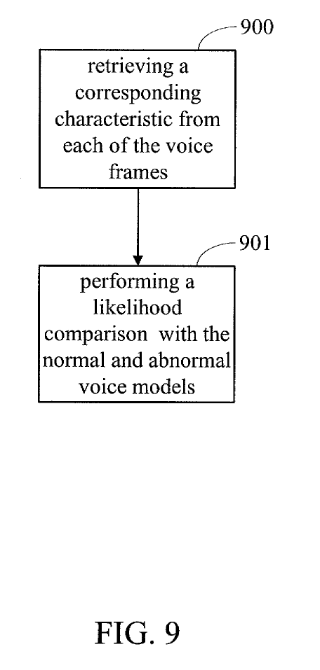

A second embodiment of the invention is shown in FIG. 8 which is a flow chart of a voice detection method. In step 800, a voice signal is received. Next, step 801 is executed for dividing the voice signal into a plurality of voice frames and two adjacent voice frames might overlap. Next, step 802 is executed for comparing each of the voice frames with the pre-stored normal and abnormal voice models to generate a plurality of first likelihood values and second likelihood values. More particularly, as shown in FIG. 9, step 802 further comprises step 900 and step 901, wherein in step 900, at least one characteristic parameter is retrieved from each of the voice frames. The characteristic parameter can be one of a Mel-scale Frequency Cepstral Coefficients (MFCC), a Linear Predictive Cepstral Coefficient (LPCC), and a cepstral of the voice signal, or a combination thereof. In step 901, the pre-stored normal and abnormal voice models are taken out to perform the likelihood comparison with the characteristic parameter of each of the voice frames to generate the first likelihood values and the second likelihood values, respectively. More particularly, a whole Gaussian mixture density function is mainly consists of M component densities, wherein each of the M component densities can be defined by three parameters: a mean vector, a covariance matrix and a mixture weight. In the invention, both a normal voice (the background voice) and an abnormal voice have a corresponding GMM model λ which is a set of all the parameters as shown in the following equation:

λ={wᵢ,uᵢ,Σᵢ}, i=1 . . . M

wherein wᵢ represents the mixture weight, μᵢ represents the mean vector, Σᵢ represents the covariance matrix, and M represents the number of a Gaussian distribution. The Gaussian mixture density is a weighted sum of M component densities (i.e., λ) as shown in the following equation:

$$p \text{(} x \vert λ ) = {\sum }_{i = 1}^{M} {w}_{i} {b}_{i} ( x )$$

wherein x is a random vector in D dimensions or a characteristic vector of one voice frame in D dimensions, bᵢ(x), i=1, . . . , M is component densities, wᵢ, i=1, . . . , M is mixture weights satisfying a limitation that a summation of all M mixture weights should be 1, i.e.,

$${\sum }_{i = 1}^{M} {w}_{i} = 1.$$

Each of the component densities bᵢ(x), i=1, . . . , M is the D dimensional Gaussian density function as shown in the following equation:

$${b}_{i} ( x ) = \frac{1}{{( 2 π )}^{D / 2} {\vert {\sum }_{i} \vert}^{1 / 2}} exp \{ - \frac{1}{2} {( x - {μ}_{i} )}^{T} {\sum }_{i}^{- 1} ( x - {μ}_{i} ) \} , \\ i = 1 , … , M$$

wherein μᵢ is the mean vector and Σᵢ is the covariance matrixe.

Assuming that λ₁ and λ₂ respectively represents a GMM model for a normal voice and a GMM model for an abnormal voice, and xᵢ represents a sequence of voice frames, a plurality of likelihood values A and a plurality of likelihood values B are generated after performing the likelihood calculation on each of the voice frames based on λ₁ and λ₂, i.e., based on the equation

$$p \text{(} x \vert λ ) = {\sum }_{i = 1}^{M} {w}_{i} {b}_{i} ( x ) \text{)} .$$

After performing a logarithm operation on the likelihood A and B, a plurality of likelihood log values C and a plurality of likelihood log values D are obtained. The likelihood log values C and D are the first likelihood values 310 and the second likelihood values 311, wherein the first likelihood values are the results of performing the likelihood comparison on the normal voice model and the characteristic parameter, and the second likelihood values are the results of performing the likelihood comparison on the abnormal voice model and the characteristic parameter.

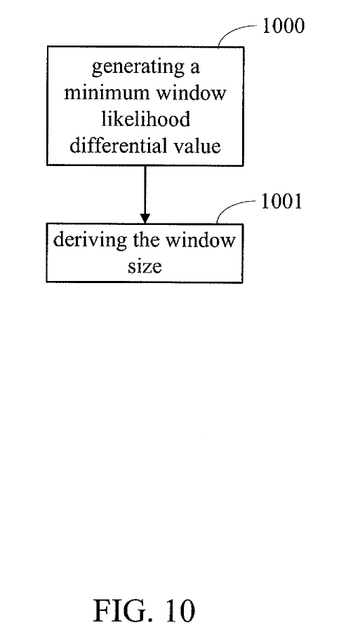

Next, step 803 is executed for deciding a window size. More particularly, as shown in FIG. 10, step 803 comprises step 1000 and step 1001. In step 1000, the first likelihood values and the second likelihood values are accumulated respectively based on a predetermined minimum window. More particularly, as shown in FIG. 6, the voice signal is a continuous signal with an assumed length of 10 seconds, and the size of the voice frame and the size of a minimum window 600 are 5 ms and 100 ms, respectively. The first calculation module 500 individually accumulates the 20 first likelihood values and the 20 second likelihood values that locate from the beginning to 100 ms and takes the difference of the accumulation results of the first likelihood values and the second likelihood values to generate the minimum window likelihood differential value.

FIG. 7 shows how to derive the window size. A first weighting linear equation M₁ and a second weighting linear equation M₂ in FIG. 7 are shown as follows:

$${M}_{1} ( N ) = \{ \begin{matrix} 1 & N \leq {N}_{1} \\ \frac{{N}_{2} - N}{{N}_{2} - {N}_{1}} & {N}_{1} \leq N \leq {N}_{2} \\ 0 & N \geq {N}_{2}\end{matrix} \\ {M}_{2} ( N ) = \{ \begin{matrix} 0 & N \leq {N}_{1} \\ \frac{N - {N}_{1}}{{N}_{2} - {N}_{1}} & {N}_{1} \leq N \leq {N}_{2} \\ 1 & N \geq {N}_{2}\end{matrix}$$

Assuming that the minimum window likelihood differential value N derived in step 1000 equals to 480, by utilizing the aforementioned first weighting linear equation M₁ and the second weighting linear equation M₂, step 1001 is executed for deriving that M₁(N) is 0.4 and M₂(N) is 0.6.

Furthermore, the number of the voice frames N can be substituted into the following linear equation to derive parameters f₁(N) and f₂(N):

f₁(N)=a₁·N+b₁

f₂(N)=a₂·N+b₂

wherein a₁, a₂, b₁ and b₂ are predetermined constants, and the settings of a₁, a₂, b₁ and b₂ constants should make f₁(N) larger and f₂(N) smaller. In other words, f₁(N) is a larger window value and f₂(N) is a smaller window value. Then, step 1101 is executed for deriving the window size according to the following equation:

$$\begin{matrix}window size = \frac{{M}_{1} ( N ) \cdot {f}_{1} ( N ) + {M}_{2} ( N ) \cdot {f}_{2} ( N )}{{M}_{1} ( N ) + {M}_{2} ( N )} \\ = 0.4 {f}_{1} ( N ) + 0.6 {f}_{2} ( N )\end{matrix}$$

By utilizing the equation to derive the window size, the window size value is a relatively larger while the minimum window likelihood differential value N is a smaller value. On the contrary, the window size value is relatively smaller, while the minimum window likelihood differential value N is a larger value. The window size mentioned here is the size of the decision window 601 in FIG. 6.

Refer back to FIG. 8. After the window size is obtained, step 804 is executed for accumulating the first likelihood values and the second likelihood values of the voice frames inside the window size to generate a first sum and a second sum, respectively. Step 805 is executed for determining whether the voice signal is abnormal according to the first sum and the second sum. If the first sum is greater, the voice signal is determined normal. Otherwise, the voice signal is determined abnormal.

In addition to the aforementioned steps, the second embodiment can execute all operations of the first embodiment. People who are ordinary skilled in the art can understand corresponding steps or operations of the second embodiment according to explanations of the first embodiment and thus no unnecessary details is given here.

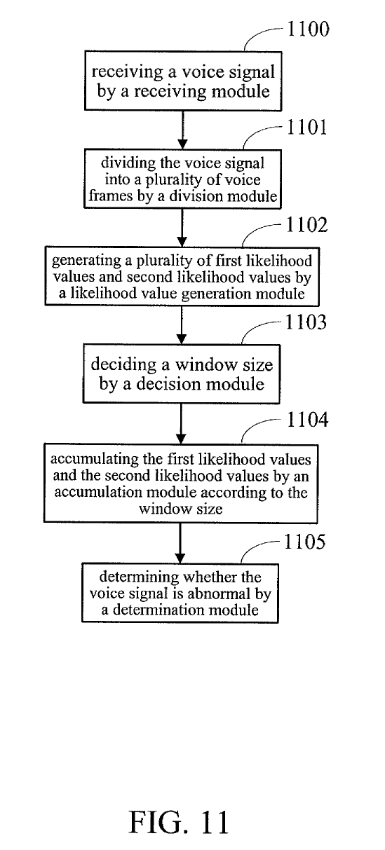

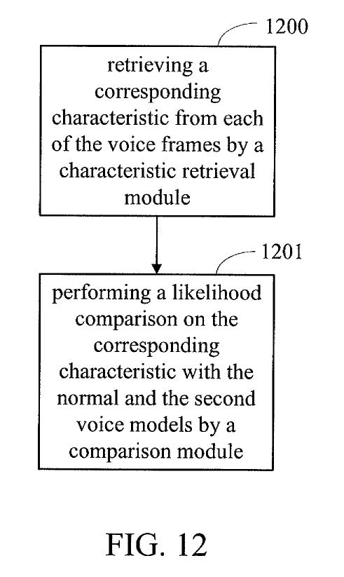

A third embodiment of the invention is shown in FIG. 11 which is a voice detection method used in a voice detection apparatus (such as the voice detection apparatus 3). In step 1100, a voice signal is received by the receiving module 300. Next, step 1101 is executed for dividing the voice signal into a plurality of voice frames 309 by the division module 302 and two adjacent voice frames of the voice frames overlap. Next, step 1102 is executed for comparing each of the voice frames 309 with the pre-stored normal and abnormal voice models by the likelihood value generation module 303 to generate a plurality of first likelihood values and second likelihood values, wherein the likelihood value generation module 303 comprises a characteristic retrieval module 400 and a comparison module 400. More particularly, step 1102 comprises the steps as shown in FIG. 12. In step 1200, at least one characteristic parameter 402 is retrieved from each of the voice frames by the characteristic retrieval module 400 and the characteristic parameter 402 can be one of a Mel-scale Frequency Cepstral Coefficients (MFCC), a Linear Predictive Cepstral Coefficient (LPCC), and a cepstral of the voice signal, or a combination thereof. In step 1201, the pre-stored normal and abnormal voice models 308 are taken out from the database 304 by the comparison module 401 to perform the likelihood comparison with the characteristic parameter 402 of each of the voice frames to generate the first likelihood values 310 and the second likelihood values 311, respectively. More particularly, a whole Gaussian mixture density function mainly consists of M component densities, wherein each of the M component densities can be defined by three parameters: a mean vector, a covariance matrix and a mixture weight. In the invention, both a normal voice (the background voice) and an abnormal voice have a corresponding GMM model λ which is a set of all the parameters as shown in the following equation:

λ={wᵢ,uᵢ,Σᵢ}, i=1 . . . M

wherein wᵢ represents the mixture weight, μᵢ represents the mean vector, Σᵢ represents the covariance matrix, and M represents the number of a Gaussian distribution. The Gaussian mixture density is a weighted sum of M component densities (i.e., λ) as shown in the following equation:

$$p \text{(} x \vert λ ) = {\sum }_{i = 1}^{M} {w}_{i} {b}_{i} ( x )$$

wherein x is a random vector in D dimensions or a characteristic vector of one voice frame in D dimensions, bᵢ(x), i=1, . . . , M is component densities, wᵢ, i=1, . . . , M is mixture weights satisfying a limitation that a summation of all M mixture weights should be 1, i.e.,

$${\sum }_{i = 1}^{M} {w}_{i} = 1.$$

Each of the component densities bᵢ(x), i=1, . . . , M is the D dimensional Gaussian density function as shown in the following equation:

$${b}_{i} ( x ) = \frac{1}{{( 2 π )}^{D / 2} {\vert {\sum }_{i} \vert}^{1 / 2}} exp \{ - \frac{1}{2} {( x - {μ}_{i} )}^{T} {\sum }_{i}^{- 1} ( x - {μ}_{i} ) \} , \\ i = 1 , … , M$$

wherein μᵢ is the mean vector and Σᵢ is the covariance matrix.

Assuming that λ₁ and λ₂ respectively represent a GMM model for a normal voice and a GMM model for an abnormal voice, and xᵢ represents a sequence of voice frames, a plurality of likelihood values A and a plurality of likelihood values B are generated after performing the likelihood calculation on each of the voice frames based on λ₁ and λ₂ i.e., based on the equation

$$p \text{(} x \vert λ ) = {\sum }_{i = 1}^{M} {w}_{i} {b}_{i} ( x ) . ,$$

After performing a logarithm operation on the likelihood A and B, a plurality of likelihood log values C and a plurality of likelihood log values D are obtained. The likelihood log values C and D are the first likelihood values 310 and the second likelihood values 311, wherein the first likelihood values 310 are the results of performing the likelihood comparison on the normal voice model and the characteristic parameter 402, and the second likelihood values 311 are the results of performing the likelihood comparison on the abnormal voice model and the characteristic parameter 402.

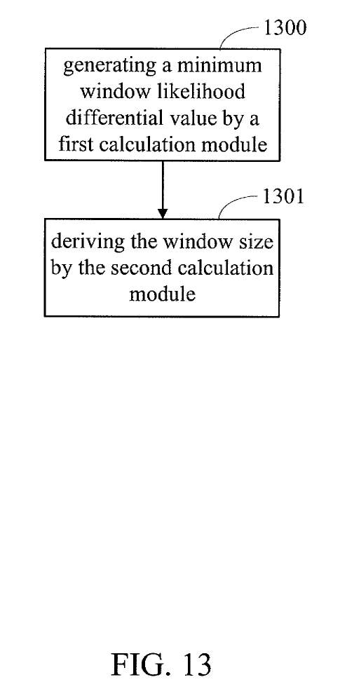

Next, step 1103 is executed for deciding a window size by the decision module 305. More particularly, the decision module 305 comprises a first calculation module 500 and a second calculation module 501 as shown in FIG. 13. Step 1103 comprises the following steps. In step 1300, the first likelihood values 310 and second likelihood values 311 are accumulated respectively by the first calculation module 500 based on a predetermined minimum window in order to generate the window size 312. As shown in FIG. 6, since the voice signal 301 has a length of 10 seconds, and the size of the voice frame and the size of a minimum window 600 are 5 ms and 100 ms, respectively. Step 1300 accumulates the 20 first likelihood values 310 and the 20 second likelihood values 311 that locate from the beginning to 100 ms and takes the difference of the accumulation results of the first likelihood values 310 and the second likelihood values 311 to generate the minimum window likelihood differential value 502.

FIG. 7 shows how to derive the window size in step 1301. As aforementioned, the first weighting linear equation M₁ and the second weighting linear equation M₂ in FIG. 7 are shown as follows:

$${M}_{1} ( N ) = \{ \begin{matrix} 1 & N \leq {N}_{1} \\ \frac{{N}_{2} - N}{{N}_{2} - {N}_{1}} & {N}_{1} \leq N \leq {N}_{2} \\ 0 & N \geq {N}_{2}\end{matrix} \\ {M}_{2} ( N ) = \{ \begin{matrix} 0 & N \leq {N}_{1} \\ \frac{N - {N}_{1}}{{N}_{2} - {N}_{1}} & {N}_{1} \leq N \leq {N}_{2} \\ 1 & N \geq {N}_{2}\end{matrix}$$

Assuming that the N derived in step 1300 equals to 480 by utilizing the aforementioned first weighting linear equation M₁ and the second weighting linear equation M₂, step 1301 is executed for deriving that M₁(N) is 0.4 and M₂(N) is 0.6.

Furthermore, the number of the voice frames N can be substituted into the following linear equation to derive parameters f₁(N) and f₂(N):

f₁(N)=a₁·N+b₁

f₂(N)=a₂·N+b₂

wherein a₁, a₂, b₁ and b₂ are a predetermined constants, and the settings of a₁, a₂, b₁ and b₂ constants should make f₁(N) larger and f₂(N) smaller, In other words, f₁(N) is a larger window value and f₂(N) is a smaller window value. Then, step 1301 is executed for deriving the window size 312 according to the following equation:

$$\begin{matrix}window size = \frac{{M}_{1} ( N ) \cdot {f}_{1} ( N ) + {M}_{2} ( N ) \cdot {f}_{2} ( N )}{{M}_{1} ( N ) + {M}_{2} ( N )} \\ = 0.4 {f}_{1} ( N ) + 0.6 {f}_{2} ( N )\end{matrix}$$

By utilizing the equation to derive the window size 312, the window size value is a relatively larger while the minimum window likelihood differential value N is a smaller value. On the contrary, the derived window size value is a relatively smaller value while the minimum window likelihood differential value N is a larger value. The window size 312 is the size of the decision window 601 in FIG. 6.

Refer back to FIG. 11. After the window size 312 is obtained, step 1104 is executed for accumulating the first likelihood values and the second likelihood values of the voice frames inside the window size by the accumulation module 306 to generate a first sum 313 and a second sum 314, respectively. Step 1105 is executed for determining whether the voice signal is abnormal according to the first sum 313 and the second sum 314 by the determination module 307. If the first sum 313 is greater, the voice signal 301 is determined normal. Otherwise, the voice signal 301 is determined abnormal.

In addition to the aforementioned steps, the third embodiment can execute all operations of the first embodiment. People who are ordinary skilled in the art can understand corresponding steps or operations of the third embodiment according to explanations of the first embodiment and thus no unnecessary details is given here.

The above-mentioned methods may be implemented via an application program which stored in a computer readable medium. The computer readable medium can be a floppy disk, a hard disk, an optical disc, a flash disk, a tape, a database accessible from a network or any storage medium with the same functionality that can be easily thought by people skilled in the art.

While the environment voice or background voice of a voice signal has a significant change, the invention can dynamically adjust the window size for decreasing the false possibility of the detection so that the response is instant and correct. Especially for the security assurance applications, the invention can detect an abnormal voice more precisely so a real-time response can be transmitted to a security service office in time.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A voice detection apparatus, comprising:
a receiving module for receiving a voice signal;
a division module for dividing the voice signal into a plurality of voice frames;
a likelihood value generation module for comparing each of the voice frames with a first voice model and a second voice model to generate a plurality of first likelihood values and second likelihood values;
a decision module for deciding a window size according to the first likelihood values and the second likelihood values;
an accumulation module for accumulating the first likelihood values and the second likelihood values inside the window size to generate a first sum and a second sum; and
a determination module for determining whether the voice signal is abnormal according to the first sum and the second sum.

2. The voice detection apparatus as claimed in claim 1, wherein the likelihood value generation module comprises:
a characteristic retrieval module for retrieving a corresponding characteristic from each of the voice frames; and
a comparison module for performing a likelihood comparison on the corresponding characteristic with the first voice model and the second voice model to generate the first likelihood values and second likelihood values.

3. The voice detection apparatus as claimed in claim 1, wherein the decision module comprises:
a first calculation module for accumulating the first likelihood values and second likelihood values inside a predetermined minimum window, and for performing subtraction on an accumulation result of the first likelihood values and an accumulation result of the second likelihood values to generate a minimum window likelihood differential value N; and
a second calculation module for, according to the N, deriving a first weight parameter M₁(N) based on a first weight equation, deriving a second weight parameter M₂(N) based on a second weight equation, deriving a first parameter f₁(N) based on a first linear equation, deriving a second parameter f₂(N) based on a second linear equation, and deriving the window size based on the following equation:
$$the window size = \frac{{M}_{1} ( N ) \cdot {f}_{1} ( N ) + {M}_{2} ( N ) \cdot {f}_{2} ( N )}{{M}_{1} ( N ) + {M}_{2} ( N )}$$

4. The voice detection apparatus as claimed in claim 3, wherein the first weight parameter Mₗ(N) is:
$${M}_{1} ( N ) = \{ \begin{matrix} 1 & N \leq {N}_{1} \\ \frac{{N}_{2} - N}{{N}_{2} - {N}_{1}} & {N}_{1} \leq N \leq {N}_{2} \\ 0 & N \geq {N}_{2}\end{matrix}$$
wherein N₁ is a predetermined first minimum window likelihood difference constant, and N₂ is a predetermined second minimum window likelihood difference constant.

5. The voice detection apparatus as claimed in claim 3, wherein the second weight parameter M₂(N) is:
$${M}_{2} ( N ) = \{ \begin{matrix} 0 & {N}_{1} \leq N \leq {N}_{2} \\ \frac{N - {N}_{1}}{{N}_{2} - {N}_{1}} & N \leq {N}_{1} \\ 1 & N \geq {N}_{2}\end{matrix}$$
wherein N₁ is a predetermined first minimum window likelihood difference constant, and N₂ is a predetermined second minimum window likelihood difference constant.

6. The voice detection apparatus as claimed in claim 1, wherein two adjacent voice frames of the voice frames overlap.

7. A voice detection method, comprising the following steps:
receiving a voice signal;
dividing the voice signal into a plurality of voice frames;
comparing each of the voice frames with a first voice model and a second voice model to generate a plurality of first likelihood values and second likelihood values;
deciding a window size according to the first likelihood values and the second likelihood values;
accumulating the first likelihood values and the second likelihood values inside the window size to generate a first sum and a second sum; and
determining whether the voice signal is abnormal according to the first sum and the second sum.

8. The voice detection method according to claim 7, wherein the step of the generating likelihood values comprises the following steps:
retrieving a corresponding characteristic from each of the voice frames; and
performing a likelihood comparison on the corresponding characteristic with the first voice model and the second voice model to generate the first likelihood values and second likelihood values.

9. The voice detection method according to claim 7, wherein the deciding step further comprises the following steps:
accumulating the first likelihood values and second likelihood values inside a predetermined minimum window, and for performing subtraction on an accumulation result of the first likelihood values and an accumulation result of the second likelihood values to generate a minimum window likelihood differential value N; and
according to the N, deriving a first weight parameter M₁(N) based on a first weight equation, deriving a second weight parameter M₂(N) based on a second weight equation, deriving a first parameter f₁(N) based on a first linear equation, deriving a second parameter f₂(N) based on a second linear equation, and deriving the window size based on the following equation:
$$the window size = \frac{{M}_{1} ( N ) \cdot {f}_{1} ( N ) + {M}_{2} ( N ) \cdot {f}_{2} ( N )}{{M}_{1} ( N ) + {M}_{2} ( N )}$$

10. The voice detection method according to claim 9, wherein the first weight parameter M₁(N) is:
$${M}_{1} ( N ) = \{ \begin{matrix} 1 & N \leq {N}_{1} \\ \frac{{N}_{2} - N}{{N}_{2} - {N}_{1}} & {N}_{1} \leq N \leq {N}_{2} \\ 0 & N \geq {N}_{2}\end{matrix}$$
wherein N₁ is a predetermined first minimum window likelihood difference constant, and N₂ is a predetermined second minimum window likelihood difference constant.

11. The voice detection method as claimed in claim 9, wherein the second weight parameter M₂(N) is:
$${M}_{2} ( N ) = \{ \begin{matrix} 0 & {N}_{1} \leq N \leq {N}_{2} \\ \frac{N - {N}_{1}}{{N}_{2} - {N}_{1}} & N \leq {N}_{1} \\ 1 & N \geq {N}_{2}\end{matrix}$$
wherein N₁ is a predetermined first minimum window likelihood difference constant, and N₂ is a predetermined second minimum window likelihood difference constant.

12. The voice detection method as claimed in claim 7, wherein two adjacent voice frames of the voice frames overlap.

13. A computer readable medium storing a application program to execute a voice detection method, the voice detection method comprising the following steps:
receiving a voice signal;
dividing the voice signal into a plurality of voice frames;
comparing each of the voice frames with a first voice model and a second voice model to generate a plurality of first likelihood values and second likelihood values;
deciding a window size according to the first likelihood values and the second likelihood values;
accumulating the first likelihood values and the second likelihood values inside the window size to generate a first sum and a second sum; and
determining whether the voice signal is abnormal according to the first sum and the second sum.

14. The computer readable medium according to claim 13, wherein the step of the generating likelihood values comprises the following steps:
retrieving a corresponding characteristic from each of the voice frames; and
performing a likelihood comparison on the corresponding characteristic with the first voice model and the second voice model to generate the first likelihood values and second likelihood values.

15. The computer readable medium according to claim 13, wherein the deciding step further comprises the following steps:
accumulating the first likelihood values and second likelihood values inside a predetermined minimum window, and for performing subtraction on an accumulation result of the first likelihood values and an accumulation result of the second likelihood values to generate a minimum window likelihood differential value N; and
according to the N, deriving a first weight parameter M₁(N) based on a first weight equation, deriving a second weight parameter M₂(N) based on a second weight equation, deriving a first parameter f₁(N) based on a first linear equation, deriving a second parameter f₂(N) based on a second linear equation, and deriving the window size based on the following equation:
$$the window size = \frac{{M}_{1} ( N ) \cdot {f}_{1} ( N ) + {M}_{2} ( N ) \cdot {f}_{2} ( N )}{{M}_{1} ( N ) + {M}_{2} ( N )}$$

16. The computer readable medium according to claim 15, wherein the first weight parameter M₁(N) is:
$${M}_{1} ( N ) = \{ \begin{matrix} 1 & N \leq {N}_{1} \\ \frac{{N}_{2} - N}{{N}_{2} - {N}_{1}} & {N}_{1} \leq N \leq {N}_{2} \\ 0 & N \geq {N}_{2}\end{matrix}$$
wherein N₁ is a predetermined first minimum window likelihood difference constant, and N₂ is a predetermined second minimum window likelihood difference constant.

17. The computer readable medium according to claim 15, wherein the second weight parameter M₂(N) is:
$${M}_{2} ( N ) = \{ \begin{matrix} 0 & N \leq {N}_{1} \\ \frac{N - {N}_{1}}{{N}_{2} - {N}_{1}} & {N}_{1} \leq N \leq {N}_{2} \\ 1 & N \geq {N}_{2}\end{matrix}$$
wherein N₁ is a predetermined first minimum window likelihood difference constant, and N₂ is a predetermined second minimum window likelihood difference constant.

18. The computer readable medium according to claim 13, wherein two adjacent voice frames of the voice frames overlap.
